(19) United States
(12) Patent Application Publication
(10) Pub. No.: US 2024/0395263 A1
(43) Pub. Date: Nov. 28, 2024

(54) APPARATUS AND METHOD TO TRANSFORM AN AUDIO STREAM

(71) Applicant: Fraunhofer-Gesellschaft zur Förderung der angewandten Forschung e.V., München (DE)

(72) Inventors: Dominik WECKBECKER, Erlangen (DE); Archit TAMARAPU, Erlangen (DE); Guillaume FUCHS, Erlangen (DE); Markus MULTRUS, Erlangen (DE); Stefan DÖHLA, Erlangen (DE); Kacper SAGNOWSKI, Erlangen (DE); Stefan BAYER, Erlangen (DE)

(73) Assignee: Fraunhofer-Gesellschaft zur Förderung der angewandten Forschung e.V., München (DE)

(21) Appl. No.: 18/793,735

(22) Filed: Aug. 2, 2024

Related U.S. Application Data
(63) Continuation of application No. PCT/EP2023/052331, filed on Jan. 31, 2023.

(30) Foreign Application Priority Data
Feb. 3, 2022 (WO) PCT/EP2022/052642

(51) Int. Cl. G10L 19/008; G10L 19/06; G10L 19/26; G10L 25/21

(52) U.S. Cl. CPC G10L 19/008; G10L 19/06; G10L 19/265; G10L 25/21

(57) ABSTRACT

An apparatus for transforming an audio stream with more than one channel into another representation having: a transformer for transforming the audio stream in a signal-adaptive way dependent on one or more parameters; and a unit for deriving (the one or more parameters describing an acoustic or psychoacoustic model of the audio stream, said parameters comprise at least an information on DOA, wherein the one or more parameters are derived from the audio stream.

### CROSS-REFERENCE TO RELATED APPLICATIONS

This application is a continuation of copending International Application No. PCT/EP2023/052331, filed Jan. 31, 2023, which is incorporated herein by reference in its entirety, and additionally claims priority from International Application No. PCT/EP2022/052642, filed Feb. 3, 2022, which is also incorporated herein by reference in its entirety.

### BACKGROUND OF THE INVENTION

Embodiments of the present invention refer to an apparatus for transforming an audio stream with more than one channel into another representation. Further embodiments refer to a corresponding method and to a corresponding computer program.

Further embodiments refer to an apparatus for transforming an audio stream in a directional audio coding system. Further embodiments refer to a corresponding method and computer program.

Additional embodiments refer to an encoder comprising one of the above-defined apparatuses into a corresponding method for encoding as well as to a decoder comprising one of the above-discussed apparatuses and a corresponding method for decoding. Embodiments refer in general to the technical field of compression of audio channels by a prediction based on acoustic model parameters. Relevant conventional technology for the embodiments mainly comes from two previously known audio coding schemes:
Directional Audio Coding (DirAC); and
A metadata-assisted EVS codec for spatial audio that was presented in the context of the 3GPP standards organization

Both concepts will be summarized briefly:

### Directional Audio Coding

DirAC is a parametric technique for the encoding and reproduction of spatial sound fields [1, 2, 3, 4]. It is justified by the psychoacoustical argument that human listeners can only process two cues per critical band at a time [4]: the direction of arrival (DOA) of one sound source and the inter-aural coherence [4]. Consequently, it is sufficient to reproduce two streams per critical band: a directional one comprising the coherent channel signals from one point source from a given direction and a diffuse one comprising incoherent diffuse signals [4].

The analysis stage on the encoder side is depicted in the diagram of FIG. 1a. FIG. 1 shows an encoder claim having at the input side a bandpass filter 11 and two entities 12 and 13 for determining the energy and intensity. Based on the energy and intensity a diffuseness is determined by the diffuseness determiner 14 which may, for example, use a temporal averaging. The output of the diffuseness determiner 14 is ϕ. Based on the intensity a direction (Azi and Ele) is determined by the direction determiner 15. The information ϕ, Azi and Ele are output as metadata.

The input is provided in the form of four B-format channel signals and analyzed with a filter bank (FB). For each band of this FB, the DOA of the point source and the diffuseness are extracted [3, 4]. These two parameters in each band, the DOA represented by the azimuth and elevation angles and the diffuseness, comprise the DirAC metadata [3, 4], whose efficient compression has been treated in Ref. [3, 4, 5].

As it is shown by FIG. 1b, the two aforementioned streams are synthesized from the B-format signal and the metadata. The decoder 20 comprises a processor path 21 for processing the metadata ψ and a processing path 22 for processing the metadata Azi and Ele. Furthermore, the decoder 20 comprises a processing path 23 including bandpass filter and virtual microphones for processing the B-format signal (cf. Mic signal (W, X, Y, Z)). All the three processing paths 21-23 are then combined by the entity 24 including a decorrelator so as to output the loudspeaker channel signals. When decoding two loudspeakers is desired the directional stream can be obtained by panning a point source to the direction encoded in the DirAC parameters [3, 4] e.g. using vector-based amplitude panning (VBAP) [6]. For the diffuse stream decorrelated signals must be fed to the loudspeakers [4].

FIG. 2 shows a DirAC encoder from (5). Same comprises a DirAC analysis 31 and a subsequent spatial metadata encoder 32. The DirAC analysis processes the B-format so as to output the diffuseness and direction parameter to the spatial meta encoder 32. In parallel the B-format is performed by an entity for beamforming/signal selection (cf. reference numeral 33). The output of the entity 33 is then processed by the EVS encoder 34. FIG. 3 shows the corresponding DirAC decoder. The DirAC decoder of FIG. 3 comprises a spatial metadata decoder 41 and an EVS decoder 42. Both decoded signals are then used by the DirAC synthesis 43 so as to output the loudspeaker channels or FOA/HOA.

An extension of this system to higher-order Ambisonics (HOA) together with multi-channel (MC) or object based audio has been presented by Fuchs et al. [5]. There, the authors propose to perform additional processing of the B-format input signal in order to select suitable downmix channels or find suitable beams of virtual microphones to capture the transport streams as depicted in FIG. 2, numeral 33. These transport streams are then encoded using an EVS encoder. On the decoder side, the corresponding decoder is applied. The signal paths in the encoder and decoder can be seen in FIGS. 2 and 3. In addition, a sophisticated encoding scheme (cf. 32 in FIG. 2) is presented to ensure the transmission of the metadata at the lowest possible bitrate without any perceptible quality loss [5]. In contrast to the system of Ref. [2], the decoder output signal can be generated in HOA format again such that an arbitrary renderer can be employed to obtain the headphone or loudspeaker signals.

Hence, the stream of data transmitted from the encoder to the decoder must contain both the EVS bitstreams and the DirAC metadata streams and care must be taken to find the optimal distribution of the available bits between the metadata and the individual EVS-coded channels of the downmix.

### Metadata Assisted EVS Codec

An alternative approach to the encoding and reproduction of spatial audio recordings that has previously been proposed in standards organizations is a metadata-assisted EVS coder [7]. It is also referred to as spatial audio reconstruction (SPAR) [7]. FIG. 4 shows the signal paths from the encoder input to the decoder output. Like DirAC, the SPAR encoder extracts metadata and a downmix from the FOA or HOA input signal [7]. This processing is performed in a FB domain [7] here too.

FIG. 4 shows a metadata assisted EVS coder for spatial audio as shown in [7]. The EVS coder 50 comprises a content ingestion engine 51 receiving the M objects, HOA scenes and channels so as to output the M objects together with the N^{th} order Ambisonics channels to a SPAR encoder 52. The SPAR encoder comprises downmix and WXYZ engine compaction transform. The SPAR metadata and FOA data are output together with the object metadata to the EVS and metadata encoder 53. This data stream is then processed by the mode switch 54 which distributes the high immersive quality data and low immersive quality data (SPAR metadata and object metadata together with FOA and prediction metadata) to the respective coders. The high immersive coder is marked by the reference numeral 55a and 55b, wherein the lower immersive coder is marked by the reference numeral 56a and 56b.

The downmix is performed in such a way that an energy compaction of the FOA signal is achieved (see FIG. 4) and then encoded using up to 4 instances of the EVS mono encoder. These steps are analogous to the beamforming or channel selection and EVS encoding steps in DirAC in FIG. 2. On the decoder side, the FOA signal is reconstructed from the compacted downmix channels and the metadata, which contain the predictor coefficients (PC) [7]. According to the pseudocode in Ref. [7], this is realized by a band-wise multiplication of a smaller number of channels by a gain matrix. HOA signals can also be reconstructed using the transmitted SPAR metadata [7]. The metadata stream is compressed for transport by Huffman coding [7].

### Head Tracking in Spatial Audio Reproduction

When spatial sound scenes are to be reproduced on headphones, it is needed to track the movement of the listeners head and rotate the sound scene accordingly in order to produce a consistent and realistic experience. To this end, a widely-adopted technique is to rotate the scene in the Ambisonics domain by pre-multiplication of a rotation matrix to the vector of channel signals [8, 9, 0]. This rotation matrix is typically computed by the method of Ref. [11]. An alternative approach is to render the output signal to virtual loudspeakers and perform the rotation by amplitude panning [9, 6].

All of the above-described solutions have drawbacks as will be discussed below. A remedy for these drawbacks is part of the invention.

In both of the systems referenced above, some of the key challenges are to (i) select the most well-suited channels of the input signal for the transport via EVS, (ii) find a representation of these channels that reduces redundancies between them, and (iii) distribute the available bitrate between the metadata and the individual EVS encoded audio streams such that the best possible perceptual quality is attained. As these decisions are highly dependent on the signal characteristics, signal-adaptive processing must be implemented.

### SUMMARY

An embodiment may have an apparatus for transforming an audio stream with more than one channel into another representation, apparatus being on an encoder side and having: means for deriving one or more parameters describing an acoustic or psychoacoustic model of the audio stream on the encoder side, wherein the means for deriving are configured to calculate prediction coefficients as the one or more parameters, wherein the prediction coefficients are calculated based on a covariance matrix by the means for deriving; means for transforming the audio stream in a signal-adaptive way dependent on the one or more parameters; and wherein the one or more parameters have at least an information on at least one direction of arrival (DOA), wherein the means for transforming are configured to perform a downmixing or other transforming of the audio stream on the encoder side.

Another embodiment may have an apparatus for transforming an audio stream with more than one channel into another representation apparatus being on a decoder side and having: means for receiving one or more parameters describing an audio scene with an acoustic or psychoacoustic model on the decoder side; means for transforming the audio stream in a signal-adaptive way dependent on the one or more parameters; and wherein the one or more parameters have at least an information on at least one direction of arrival (DOA), wherein the means for transforming are configured to perform upmix or other transform generation of the audio stream on the decoder side.

Another embodiment may have an apparatus for transforming an audio stream in a directional audio coding system, being on an encoder side and having: means for deriving one or more acoustic model parameters of a model of the audio stream, wherein the one or more acoustic model parameters are transmitted to enable restoring all channels of the audio stream and have at least an information on direction of arrival (DoA), means for transforming the audio stream in a signal-adaptive way dependent on the one or more acoustic model parameters; where all or a subset of the channels of the audio stream are transformed; wherein the means for transforming are configured to perform a downmixing or other transforming of the audio stream on the encoder side.

Another embodiment may have an apparatus for transforming an audio stream in a directional audio coding system, apparatus being on a decoder side and having: means for receiving one or more acoustic model parameters of a model of the audio stream, wherein the one or more acoustic model parameters are received to restore all channels of the audio stream and have at least an information on direction of arrival (DoA), means for transforming the audio stream in a signal-adaptive way dependent on the one or more acoustic model parameters; where all or a subset of the channels of the audio stream are transformed; wherein the means for transforming are configured to perform upmix or other transform generation of the audio stream on the decoder side.

Another embodiment may have an encoder having an apparatus for transforming an audio stream with more than one channel into another representation, apparatus being on an encoder side and having: means for deriving one or more parameters describing an acoustic or psychoacoustic model of the audio stream on the encoder side, wherein the means for deriving are configured to calculate prediction coefficients as the one or more parameters, wherein the prediction coefficients are calculated based on a covariance matrix by the means for deriving; means for transforming the audio stream in a signal-adaptive way dependent on the one or more parameters; and wherein the one or more parameters have at least an information on at least one direction of arrival (DOA), wherein the means for transforming are configured to perform a downmixing or other transforming of the audio stream on the encoder side.

Another embodiment may have a decoder having an apparatus for transforming an audio stream with more than one channel into another representation apparatus being on a decoder side and having: means for receiving one or more parameters describing an audio scene with an acoustic or psychoacoustic model on the decoder side; means for transforming the audio stream in a signal-adaptive way dependent on the one or more parameters; and wherein the one or more parameters have at least an information on at least one direction of arrival (DOA), wherein the means for transforming are configured to perform upmix or other transform generation of the audio stream on the decoder side.

According to another embodiment, a system may have an inventive encoder and an inventive decoder, wherein the encoder is configured to calculate a prediction matrix and/or a downmix or other transform and wherein the decoder is configured to calculate an upmix or other transform matrix from estimated parameters or the one or more parameters of the acoustic model independently of each other.

Another embodiment may have a method for transforming an audio stream with more than one channel into another representation, performed on an encoder side and having the following steps: deriving the one or more parameters describing an acoustic or psychoacoustic model of an audio stream from the audio stream, wherein deriving has calculating prediction coefficients as the one or more parameters, wherein the prediction coefficients calculated are calculated based on a covariance matrix by the means for deriving and wherein the one or more parameters have at least an information on direction of arrival (DOA); and transforming the audio stream in a signal-adaptive way dependent the on one or more parameters; wherein transforming has a downmixing or other transforming of the audio stream on the encoder side.

Another embodiment may have a method for transforming an audio stream with more than one channel into another representation, performed on a decoder side and having the following steps: receiving one or more parameters describing an audio scene with an acoustic or psychoacoustic model on the decoder side, wherein the one or more parameters have at least an information on direction of arrival (DOA); and transforming the audio stream in a signal-adaptive way dependent the on one or more parameters; wherein transforming has upmixing or other transforming of the audio stream on the decoder side.

Another embodiment may have a method for transforming an audio stream in a directional audio coding system, performed on an encoder side and having the steps of: deriving one or more acoustic model parameters of a model of the audio stream parametrized by direction of arrival (DOA) and diffuseness or energy-ratio parameters, said acoustic model parameters are transmitted to restore all channels of an input of audio stream and have at least an information on DOA, wherein all or a subset of the channels of the audio stream are transformed; and transforming the audio stream in a signal-adaptive way dependent on one or more acoustic model parameters, wherein transforming has a downmixing or other transforming of the audio stream on the encoder side.

Another embodiment may have a method for transforming an audio stream in a directional audio coding system, performed on a decoder side and having the steps of: receiving one or more acoustic model parameters of a model of the audio stream parametrized by direction of arrival (DOA) and diffuseness or energy-ratio parameters, said acoustic model parameters are received to restore all channels of an input of audio stream and have at least an information on DOA, wherein all or a subset of the channels of the audio stream are transformed; and transforming the audio stream in a signal-adaptive way dependent on one or more acoustic model parameters, wherein transforming has upmixing or other transforming of the audio stream on the decoder side.

Another embodiment may have a non-transitory digital storage medium having stored thereon a computer program for performing any of the above methods according to the invention, when the computer program is run by a computer.

An embodiment of the present invention provides an apparatus for transforming an audio stream with more than one channel into another representation. The apparatus comprises means for transforming and means for deriving and/or means for receiving. The means for transforming are configured to transform the audio stream in a signal-adaptive way dependent on one or more parameters. The means for deriving are configured to derive the one or more parameters describing an acoustic or psychoacoustic model of the audio stream (signal). Note at the decoder side the prediction parameter can be received (cf. means for receiving). Said parameters comprise at least an information on D OA (direction of arrival), where the one or more parameters may be derived from the audio stream, e.g. at the encoder side (or just received, e.g. at the decoder side).

According to further embodiments, the means for deriving are configured to calculate prediction coefficients or to calculate prediction coefficients based on a covariance matrix or on parameters of an acoustic signal.

According to embodiments, the means for deriving are configured to calculate a covariance matrix from the model/acoustic model or in general based on the DOA or an additional diffuseness factor or an energy ratio.

It should be noted that according to embodiments the one or more parameters comprise prediction parameters.

Embodiments of the present invention are based on the principle that prediction coefficients on both the encoder and decoder side can be approximated from a model like an acoustic model or acoustic model parameters. In directional audio coding systems, these parameters are present at the decoder side and, consequently, no additional metadata bits are transmitted for the prediction. Thus, the amount of additional metadata needed to enable the reconstruction of the downmix channels at the decoder side is strongly reduced as compared to the naïve implementation of prediction. Expressed in other words, this means that the combination of deriving one or more parameters describing an acoustic model and transforming the audio stream in a signal adaptive way provides an approach to compress downmix channels in directional audio coding systems or other applications via the application of inter-channel prediction based on acoustic models of the input signal.

In the above-discussed embodiments, mainly a DOA parameter has been discussed. According to further embodiments, additionally a diffuseness information/diffuseness factor may be used. Thus, said parameters used for the means for transforming and derived by the means for deriving may comprise an information on a diffuseness factor or on one or more DOAs or on energy ratios. For example, the one or more parameters are derived from the audio stream itself.

Regarding the prediction coefficients, it should be mentioned that according to further embodiments, the prediction coefficients are calculated based on the real or complex spherical harmonics Y_{l,m} with degree l and index m evaluated at angles corresponding to a DOA

Regarding the covariance matrix, it should be noted that according to further embodiments, the means for deriving are configured to calculate a covariance matrix based on an information about diffuseness, spherical harmonics and a time-dependent scalar-valued signal. For example, the calculation may be based on the following formula:

$${C}_{x / y / z , w} = \int dt {s}^{2} ( t ) {Y}_{0 , 0} ( {θ}_{D} ) {Y}_{1 , - 1 / 0 / 1} ( {θ}_{D} )$$

where Y_{l,m} is a spherical harmonic with the degree and index l and m and where s(t) is a time-dependent scalar-valued signal.

According to further embodiments, the calculation may be based on a signal energy, for example, by using the following formula:

$${C}_{x / y / z , w} = ( 1 - Ψ ) {EY}_{0 , 0} ( {θ}_{D} ) {Y}_{1 , - 1 / 0 / 1} ( {θ}_{D} )$$

where E describes the signal energy.

Alternatively or additionally, the following formula may be used:

$${C}_{w , w} = ( 1 - Ψ ) {EY}_{0 , 0} ( {θ}_{D} ) {Y}_{0 , 0} ( {θ}_{D} ) + Ψ E$$

where E is again the signal energy.

Alternatively or additionally, the following formula may be used:

$${C}_{x , x} = ( 1 - Ψ ) {EY}_{1 , - 1} ( {θ}_{D} ) {Y}_{1 , - 1} ( {θ}_{D} ) + \frac{Ψ}{3} E$$

and analogously for the y and z channels.

According to embodiments, the energy E is directly calculated from the audio stream (signal). Alternatively or additionally, the energy E is estimated from the model of the signal.

According to further embodiments, the audio stream is preprocessed by a parameter estimator or a parameter estimator comprising as metadata encoder or metadata decoder and/or by an analysis filterbank.

According to further embodiments, the input audio stream is a higher-order Ambisonics signal and the parameter estimation is based on all or a subset of these input channels. For example, this subset can comprise the channels of the first order. Alternatively it can consist of the planar channels of any order or any other selection of channels.

As discussed above, embodiments provide an encoder comprising the above-discussed apparatus. Further embodiments provide a decoder comprising the above-discussed apparatus. On the encoder side, the apparatus may comprise means for transforming which are configured to perform a mixing, e.g. a downmixing of the audio stream. On the decoder side, the means for transforming are configured to perform a mixing, e.g. an upmixing or an upmix generation of the audio streams.

The above-discussed apparatus may also be used for transforming an audio stream in a directional audio coding system. According to embodiments, the apparatus comprises means for transforming and means for deriving. The means for transforming are configured to transform the audio stream in a signal-adaptive way dependent on one or more acoustic model parameters. The means for deriving are configured to derive the one or more acoustic model parameters of a model of the audio stream (parametrized by the DOA and/or the diffuseness and/or energy-ratio parameter). Said acoustic model parameters are transmitted to restore all channels of the audio stream and comprise at least an information on DOA. The transmitted audio streams are derived by transforming all or a subset of the channels of the audio stream. According to embodiments, the transmitted parameters are quantized prior to transmission. According to embodiments, the parameters are dequantized after transmission. According to further embodiments, the parameters may be smoothed over time. According to further embodiments the quantized parameters may be compressed by means of entropy coding.

Regarding the transform, it should be noted that according to further embodiments, the transform is computed such that correlations between transport channels are reduced. According to embodiments, the inter-channel covariance matrix of an input of the audio stream is estimated from a model of the signal of the audio stream. For example, a transform matrix is derived from a covariance matrix of a model of the audio stream signal. The covariance matrix may be calculated using different methods for different frequency bands. Regarding the transformation performed by the means for transforming, it should be noted that according to an embodiment at least one of the transform methods is multiplication of the vector of the audio channels by a constant matrix. According to another embodiment, the transform methods use prediction based on the inter-channel covariance matrix of an audio signal vector. According to another embodiment at least one of the transform methods uses prediction based on the inter-channel covariance matrix of the model signal described by DOAs and/or diffuseness factors and/or energy ratios.

According to another embodiment, and mainly applicable for the apparatus for transforming an audio stream in a directional audio coding system, the scene encoded by the audio stream (signal) is rotatable in such a way that
a vector of audio transport channel signals is pre-multiplied by a rotation matrix;
model parameters are transformed in accordance with the transform of a transport channel signal; and
non-transport channels of an output signal are reconstructed using the transformed model parameters.

As discussed above, the apparatus may be applied to an encoder and a decoder. Another embodiment provides a system comprising an encoder and a decoder. The encoder and the decoder are configured to calculate a prediction matrix and/or a downmix and/or upmix matrix from the estimated or transform parameters of the acoustic model independently of each other.

According to further embodiments, the above-discussed approach may be implemented by a method. Another embodiment provides a method for transforming an audio stream with more than one channel into another representation, comprising the following steps:
deriving or receiving the one or more parameters describing an acoustic or psychoacoustic model of an audio stream from the audio stream, said parameters comprise at least an information on DOA; and
transforming the audio stream in a signal-adaptive way dependent on one or more parameters.

Another embodiment provides a method for transforming an audio stream in a directional audio coding system, comprising the steps:
deriving the one or more acoustic model parameters of a model of the audio stream (parametrized by DOAs and diffuseness parameters or energy ratios), said acoustic model parameters are transmitted to restore all channels of an input of audio stream and comprise at least an information on DOAs, wherein the transmitted audio stream is derived by transforming all or a subset of the channels of the audio stream; and
transforming the audio stream in a signal-adaptive way dependent on one or more acoustic model parameters.

According to further embodiments, the method may computer implemented. Thus, an embodiment provides a computer program for performing, wherein running on a computer, the method according to the above-disclosure.

### BRIEF DESCRIPTION OF THE DRAWINGS

Embodiments of the present invention will be detailed subsequently referring to the appended drawings, in which:

FIGS. 1a and 1b shows a schematic representation of a DirAC analysis and synthesis;

FIG. 2 shows a schematic representation of a DirAC encoder;

FIG. 3 shows a schematic representation of a DirAC decoder;

FIG. 4 shows a schematic representation of a metadata assisted EVS: for a spatial audio;

FIG. 5a shows covariance matrix elements for one frequency band as a function of the frame number (time) for a signal comprising only one panned point source, where model and exact matrices agree very well (to illustrate embodiments);

FIG. 5b shows covariance matrix elements for one frequency band as a function of the frame number (time) for a signal from an EigenMike recording (model and exact matrices show good qualitative agreement) to illustrate embodiments;

FIG. 6 shows a schematic representation of an apparatus for transforming an audio stream (as part of a decoder and/or encoder) according to a basic embodiment; and

FIGS. 7a and b shows a schematic representation of a DirAC system with predictive coding of the transport channels according to further embodiments.

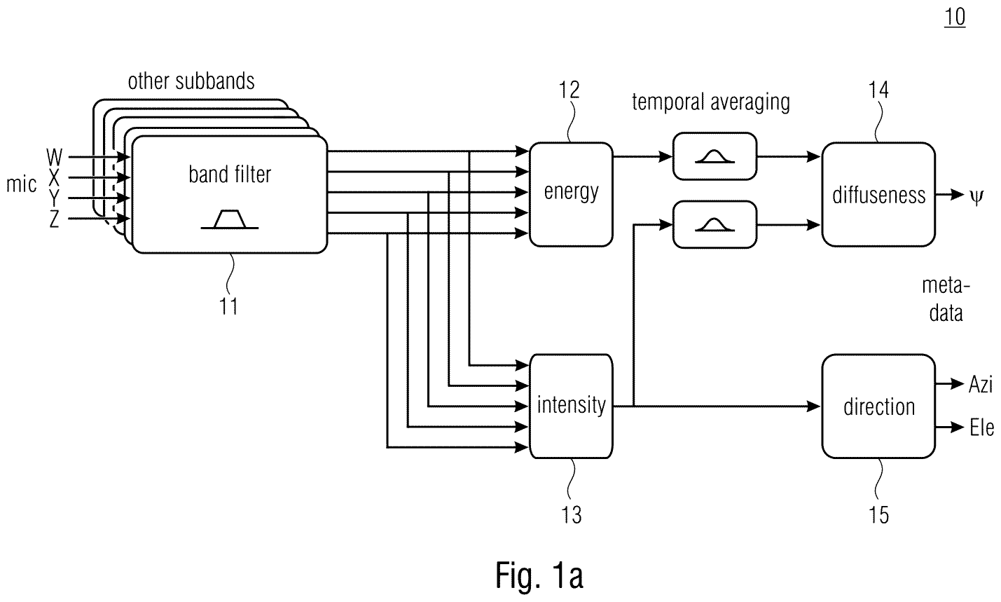

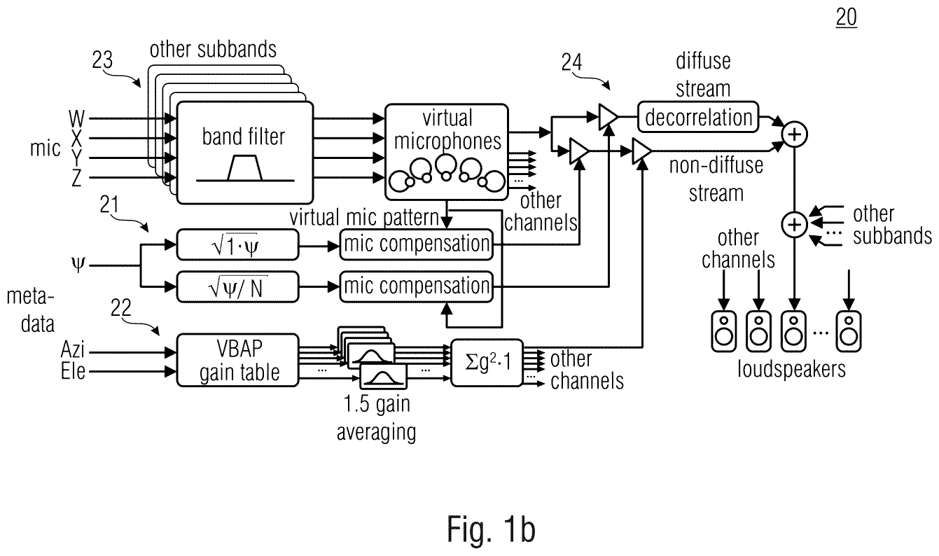

### DETAILED DESCRIPTION OF THE INVENTION

Below, embodiments of the present invention will subsequently be discussed referring to the enclosed figures, wherein identical reference numerals are provided to objects that have an identical or similar function, so that the description thereof is interchangeable or mutually applicable.

Before discussing embodiments of the present invention a discussion of some features of the invention will be given separately.

### Channel Compression

For the compression of the transport channels it is known that the optimal decorrelation and therefore energy compaction would be obtained by the Karhunen-Loève transform (KLT) (see e.g. [12]). The KLT transforms the signal vector to a basis of the eigenvectors of the inter-channel covariance matrix. For a B-format input signal of the form

$${S}_{B} ( t ) = [ \begin{matrix}w ( t ) \\ x ( t ) \\ y ( t ) \\ z ( t )\end{matrix} ] \qquad ( 1 )$$

the elements of the inter-channel covariance matrix

$$C [ {S}_{B} ( t ) ] = ( \begin{matrix}{C}_{w , w} & {C}_{w , x} & {C}_{w , y} & {C}_{w , z} \\ {C}_{x , w} & {C}_{x , x} & {C}_{x , y} & {C}_{x , z} \\ {C}_{y , w} & {C}_{y , x} & {C}_{y , y} & {C}_{y , z} \\ {C}_{z , w} & {C}_{z , x} & {C}_{z , y} & {C}_{z , z}\end{matrix} ) \qquad ( 2 )$$

are given by

$${C}_{x , w} = \int dtw ( t ) x ( t ) \qquad ( 3 )$$

and analogously for the other channel combinations. With the KLT, the matrix 2 is diagonalized and all inter-channel correlations are fully removed, therefore yielding the least redundant representation of the signal. There are, however, two difficulties which prevent the implementation of the KLT in most real-world systems: the computational complexity of the needed eigenvector calculations and the metadata bit usage for the transmission of the resulting transform matrices are often considered too high.

### Prediction

As a compromise, one can remove only the correlations of the x, y, and z with the w channel via the prediction matrix

$$P = ( \begin{matrix}1 & 0 & 0 & 0 \\ - {P}_{x} & 1 & 0 & 0 \\ - {P}_{y} & 0 & 1 & 0 \\ - {P}_{z} & 0 & 0 & 1\end{matrix} ) = ( \begin{matrix}1 & 0 & 0 & 0 \\ - {C}_{x , w} / {C}_{w , w} & 1 & 0 & 0 \\ - {C}_{y , w} / {C}_{w , w} & 0 & 1 & 0 \\ - {C}_{z , w} / {C}_{w , w} & 0 & 0 & 1\end{matrix} ) . \qquad ( 4 )$$

In this approach, no matrix diagonalization is needed and only the three prediction coefficients P_{x/y/z} are to be transmitted. Depending on the frame length and the signal characteristics, the amount of metadata for this approach can still be considerable. According to our experiments this is of the order of 10 kbps. This is especially noteworthy as these metadata would be transmitted along with those needed for the DirAC system itself, raising the overall bit requirement.

This naturally invites the question as to how these two metadata streams are connected. The invention described in the following clarifies the connection between the prediction for the purpose of the compression of the DirAC or SPAR transport channels and the model parameters transmitted in DirAC to allow for the decoder-side reconstruction of the full HOA input signal. We provide a path to the re-use of metadata already transmitted as part of the DirAC system for the compression of the transport channels. Our method can therefore improve the perceptual quality of DirAC as compared to a passive downmix by a static selection of transport channels while avoiding additional metadata transmission.

### Head Tracking

Both of the approaches to scene rotation as discussed above have significant drawbacks. For the former, the computational complexity is very high due to the matrix multiplication for every sample of the signal. For the latter, the quality is less than optimal [9]. It is therefore desirable to reduce the complexity of the former method without compromising on the quality too much. Our invention provides a path to applying the rotation in a lower-dimensional space. Within the framework of the two aforementioned systems for parametric coding of spatial audio, this can be realized by combining the rotation of a subset of the channels in the Ambisonics domain with a suitable transform in the metadata domain.

### DETAILED DESCRIPTION OF EMBODIMENTS

Above it has been established that a compression of transport channels can be achieved by reducing correlations via transforms derived from the covariance matrix. The below discussion will show an approach how such transforms can be obtained independently on both the encoder and decoder side from the readily available DirAC model parameters or general acoustic model parameters.

According to embodiments a covariance matrix may be determined from the model signal.

It is considered one of the parameter bands of directional audio coding (c.f. above). For brevity, we omit the frequency-band index in the notation. First we focus on the non-diffuse directional part of the signal. Let

$${r}_{DOA} = ( \begin{matrix}cos ϕ cos θ \\ sin ϕ cos θ \\ sin θ\end{matrix} ) \qquad ( 5 )$$

be the direction of arrival (DOA) of the sound from a point source on the unit sphere specified by the compound angle variable θ_{D}:=(ϕ,θ). The sound pressure due to this source on the unit sphere is then given by

$$p ( r = 1 , {θ}_{D} , t ) = s ( t ) Ω ( {θ}_{D} ) \qquad ( 6 )$$

$$Ω ( {θ}_{D} ) = δ ( θ - {θ}_{D} ) \qquad ( 7 )$$

with the time-dependent signal s(t) and the Dirac distribution on the sphere δ(θ).

We consider a B-format or first-order Ambisonics (FOA) signal that comprises a directional part from a panned point source at r_{DOA} and an uncorrelated diffuse part with no correlation between the individual channels. The signal vector for the directional part then becomes

$$[ \begin{matrix}w ( t ) \\ x ( t ) \\ y ( t ) \\ z ( t )\end{matrix} ] = [ \begin{matrix}s ( t ) {Y}_{0 , 0} ( {θ}_{D} ) \\ s ( t ) {Y}_{1 , - 1} ( {θ}_{D} ) \\ s ( t ) {Y}_{1 , 0} ( {θ}_{D} ) \\ s ( t ) {Y}_{1 , 1} ( {θ}_{D} )\end{matrix} ] \qquad ( 8 )$$

where Y_{l,m} are the spherical harmonics with the degree and index numbers l and m. This result can be readily read off from the expansion of the Dirac function in 7 up to the first order in the spherical harmonics (see also [13]).

$$Ω ( θ ) \approx {Y}_{0 , 0} ( {θ}_{D} ) {Y}_{0 , 0} ( θ ) + {Y}_{1 , - 1} ( {θ}_{D} ) {Y}_{1 , - 1} ( θ ) + {Y}_{1 , 0} ( {θ}_{D} ) {Y}_{1 , 0} ( θ ) + {Y}_{1 , 1} ( {θ}_{D} ) {Y}_{1 , 1} ( θ ) \qquad ( 9 )$$

Together with the diffuse part, the full B-format signal then becomes

$$[ \begin{matrix}w ( t ) \\ x ( t ) \\ y ( t ) \\ z ( t )\end{matrix} ] = s ( t ) [ \begin{matrix}{Y}_{0 , 0} ( {θ}_{D} ) \\ {Y}_{1 , - 1} ( {θ}_{D} ) \\ {Y}_{1 , 0} ( {θ}_{D} ) \\ {Y}_{1 , 1} ( {θ}_{D} )\end{matrix} ] + [ \begin{matrix} & {s}_{w}^{diff} ( t ) \\ \frac{1}{\sqrt{3}} & {s}_{x}^{diff} ( t ) \\ \frac{1}{\sqrt{3}} & {s}_{y}^{diff} ( t ) \\ \frac{1}{\sqrt{3}} & {s}_{z}^{diff} ( t )\end{matrix} ] . \qquad ( 10 )$$

The prefactor of

$$\frac{1}{\sqrt{3}}$$

in the l=1.
components in the diffuse part arises from the normalization of the signal.

Given this model signal, one can now straightforwardly evaluate the covariance matrix elements. For the off-diagonal matrix elements we find

$${C}_{x / y / z , w} = \int dt {s}^{2} ( t ) {Y}_{0 , 0} ( {θ}_{D} ) {Y}_{1 , - 1 / 0 / 1} ( {θ}_{D} ) \qquad ( 11 )$$

where the terms involving integrals over the products s_{w/x/y/z}^{diff}s(t) vanish since the diffuse components are assumed to exhibit no correlations with s (t) or between each other. With the directional energy of the signal E^{dir}=∫ dt s²(t) this can be cast as

$${C}_{x / y / z , w} = {E}^{dir} {Y}_{0 , 0} ( {θ}_{D} ) {Y}_{1 , - 1 / 0 / 1} ( {θ}_{D} ) . \qquad ( 12 )$$

The diagonal matrix elements C_{w,w} becomes

$${C}_{w , w} = {E}^{dir} {Y}_{0 , 0} ( {θ}_{D} ) {Y}_{0 , 0} ( {θ}_{D} ) + {E}_{w}^{diff} . \qquad ( 13 )$$

with the diffuse energy E_{w}^{diff} defined analogously to the directional one. The other diagonal matrix elements follow in the same way.

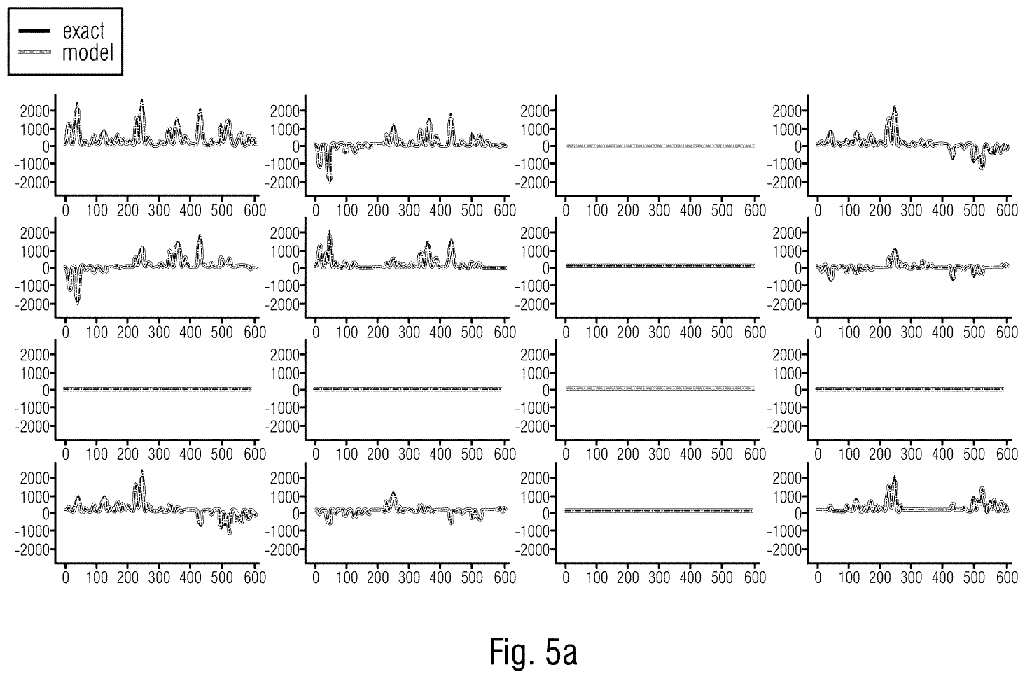

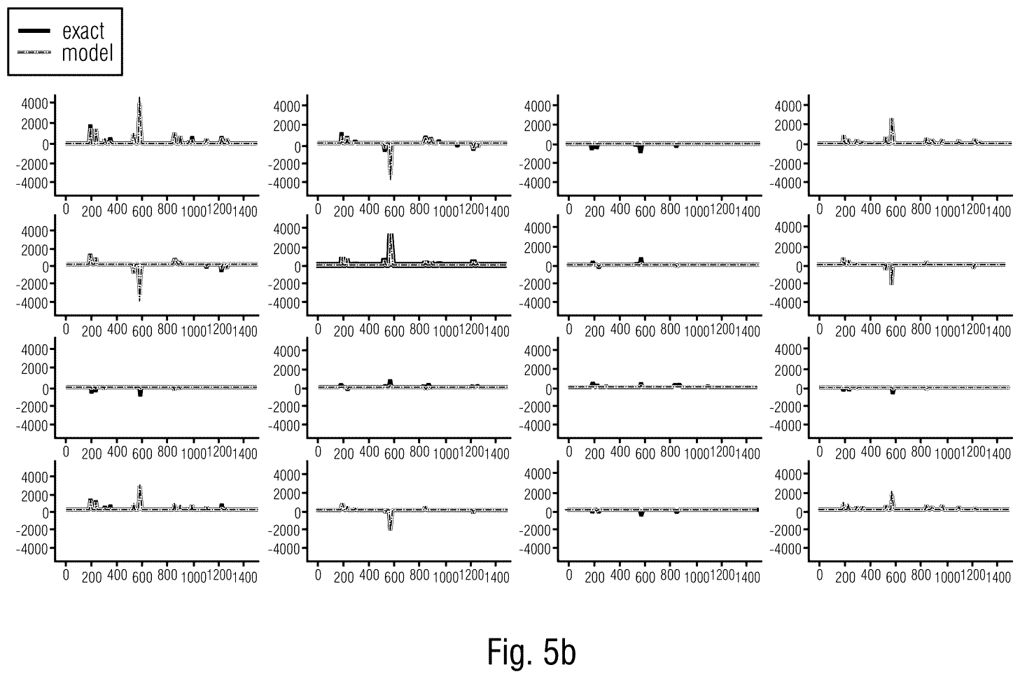

FIGS. 5a and 5b show the covariance matrix elements as a function of the time for a signal panned point source and an EigenMike recording respectively. For the point source (FIG. 5a) the agreement is very accurate as can be seen with respect to the comparison of the DirAC model signal (broken blue line) and the exact calculation signal (solid red line). For the EigenMike recording, the model captures the signal features qualitatively.

### Prediction in DirAC

Using Eqs. 4, 12, and 13 and expressing the direct and diffuse energies E^{dir} and E^{diff} by the total signal energy E, the only remaining parameters are the angles θ_{D} and the diffuseness or energy ratios which are present in the DirAC decoder at all times. Therefore, the need to transmit additional prediction coefficients can be entirely avoided.

Alternatively, the model can be enabled for a subset of the frequency bands only. For the other bands the prediction coefficients will then be calculated from the exact covariance matrix and transmitted explicitly. This can be useful in cases where a very accurate prediction is needed for the perceptually most relevant frequencies. Often it is desirable to have a more accurate reproduction of the input signal at lower frequencies, e.g. below 2 kHz. The choice of the cross-over frequencies can be motivated from two different arguments.

Firstly, the localization of sound sources is known to rely on different mechanisms for low and high frequencies [14]. While the inter-aural phase difference (IPD) is evaluated at low frequencies, the inter-aural level difference (ILD) dominates for the localization of sources at higher frequencies [14]. Therefore, it is more important to achieve a high accuracy of the prediction and a more accurate reproduction of the phases at lower frequencies. Consequently, one may wish to resort to the more demanding but more accurate transmission of the prediction parameters for lower frequencies.

Secondly, perceptual audio coders for the resulting downmix channels, because of the above argument, often reproduce low frequency bands more accurately than higher ones. For example at low bitrates, higher frequencies can be quantized to zero and restored from a copy of lower ones [15]. In order to deliver consistent quality across the whole system, it can therefore be desirable to implement a cross-over frequency according to the internal parameters of the core coder employed.

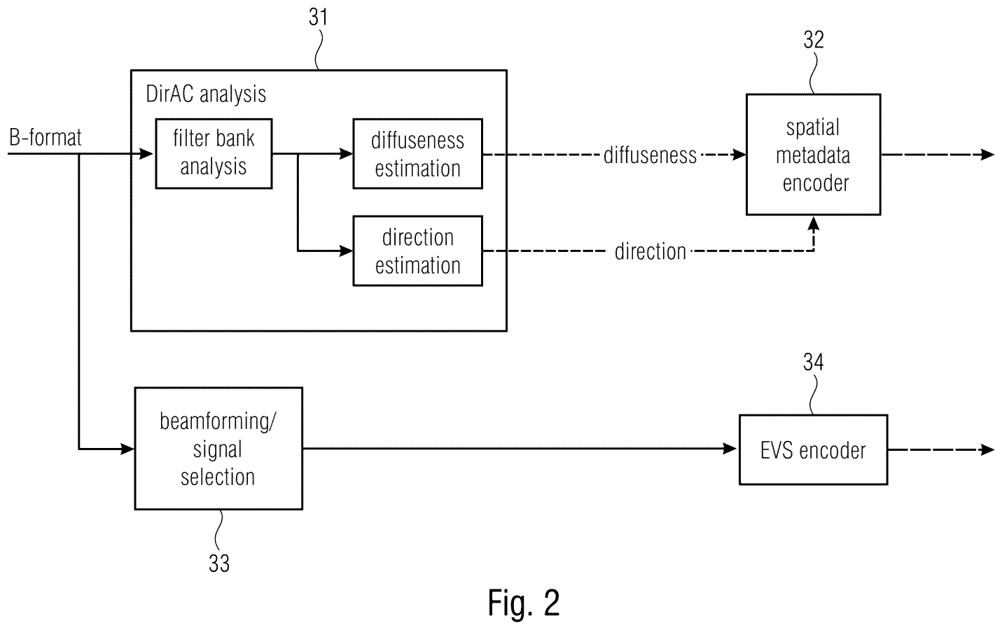

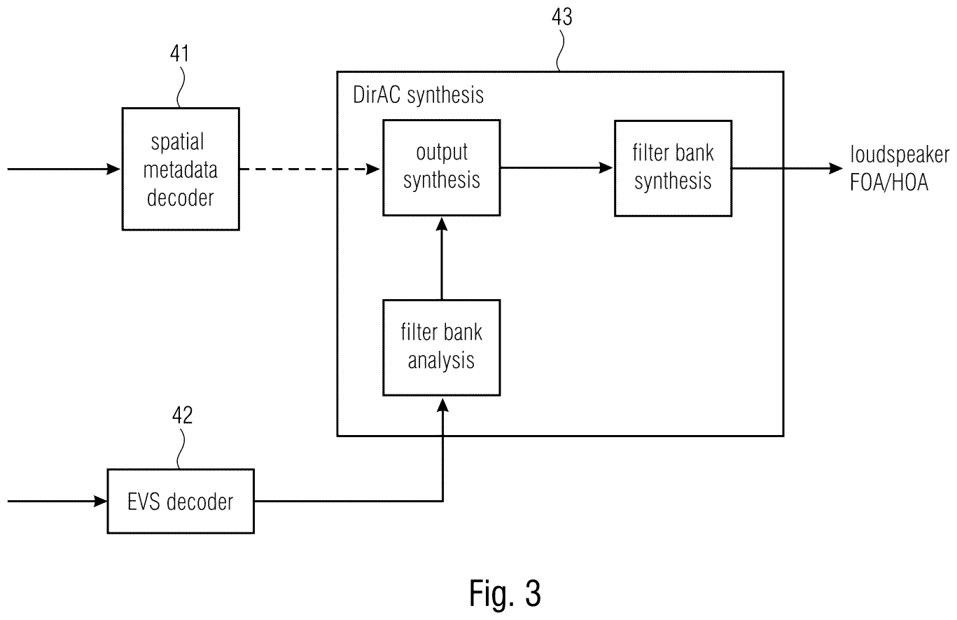

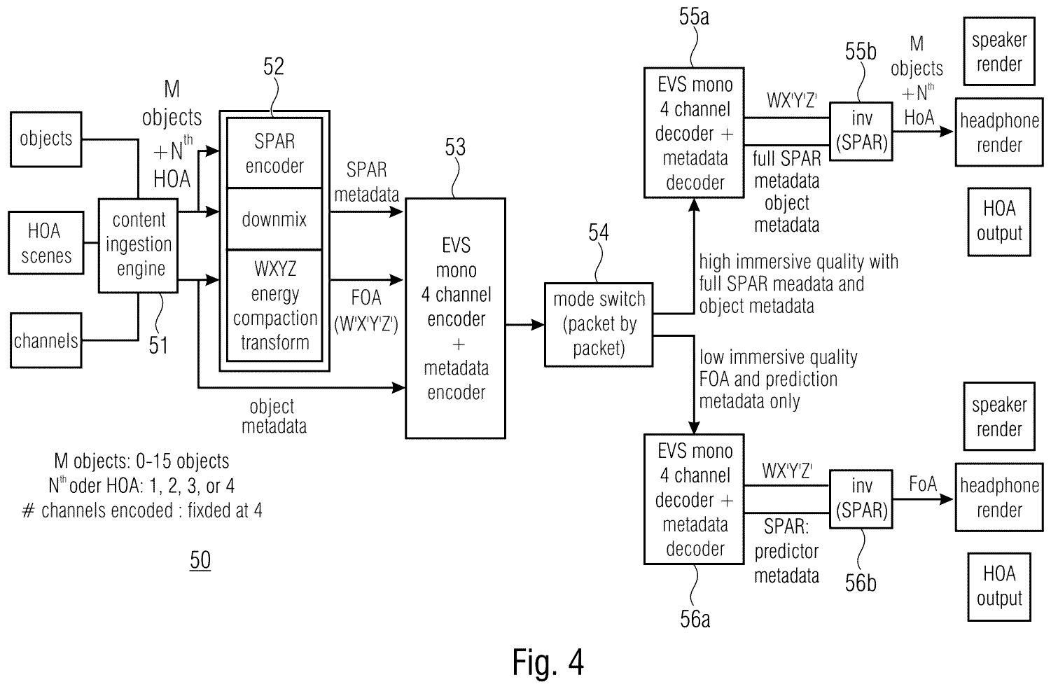

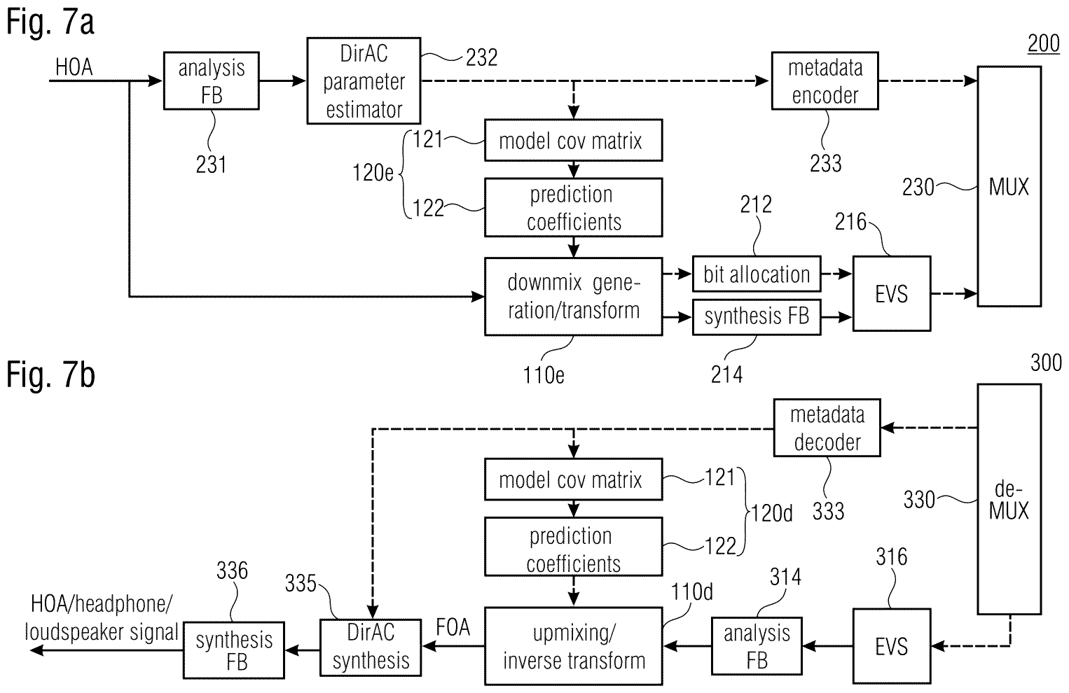

The signal path of the resulting DirAC system is depicted in FIG. 7a/b. The main improvement as compared to the previously presented system in FIGS. 2 and 3 is the adaptive compression of the transport channels using the acoustic model parameters. After the usual estimation of the DOA angles and diffuseness in each band, the model covariance matrix and the prediction coefficients are calculated according to Eqs. 12 to 14. Then the input channels are mixed down and coded using EVS. On the decoder side, the prediction coefficients are calculated from the transmitted model parameters again and the transform is inverted. Then the non-transport channels are reconstructed by the DirAC decoder as discussed above.

Head Tracking with Low Complexity

Let S_{HOA-L}(t) be the vector of the output channel signals in HOA of order L. The dimension of this vector is then given by N=(L+1)². In order to perform a rotation of the scene by the conventional method, this signal would first be reconstructed in the DirAC or SPAR decoder and multiplied by a rotation matrix R_{HOA-L} of the size N×N at each sample of the signal.

Let now Sₜᵣₐₙₛ(t) be the signal vector of the transported channels after applying the inverse transform as shown in FIG. 7, numeral 110d. The dimension of the vector Sₜᵣₐₙₛ(t) is M<N since most of the channels of S_{HOA-N}(t) are reconstructed parametrically. We now chose the order L₁ such that all channels in Sₜᵣₐₙₛ(t) belong to a basis function (spherical harmonic) with degree l≤L₁ and apply the rotation via pre-multiplication of R_{HOA-L}_{₁} to all channels up to the order L₁. Consequently all channels with l>L₁ are not affected by the rotation, leaving the signal vector in an inconsistent state.

The key novelty of our invention is now to exploit the properties of R_{HOA-L}: it is block diagonal with each belong belonging to a specific degree/and the matrix elements for l=1 are identical to those of the same rotation applied to any vector in [symbol] ³ [11]. Consequently, one can apply the l=1 block of R_{HOA-L} to the DOA vector 5 prior to the reconstruction of the channels with l>L₁. As a result, these channels are reconstructed including the scene rotation and the need to perform a matrix multiplication with the full dimensionality N can be avoided, yielding a large reduction in computational complexity.

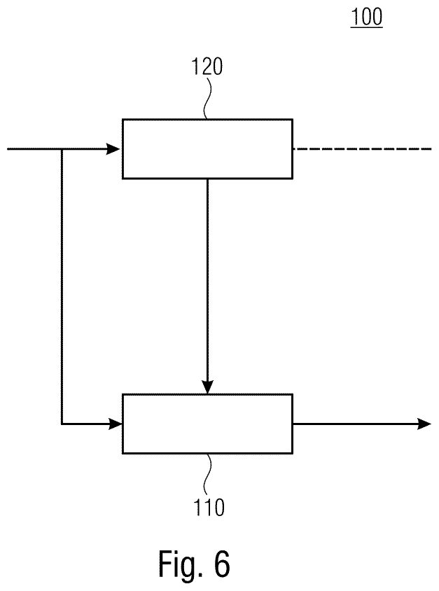

The above discussed approach can be used by an apparatus as it is shown by FIG. 6. The apparatus 100 may be part of an encoder or decoder and comprises at least means for transforming 110 and means for deriving 120. This apparatus 100 is applicable to the encoder and the decoder side. First the functionality of the apparatus at the encoder side will be discussed.

It is assumed that the apparatus 100 being part of an encoder receives a HOA representation. This representation is provided to the entities 110 and 120. For example a preprocessing of the HOAs signal, e.g. by an analysis filterbank or DirAC parameter estimator is performed (not shown). The one or more parameters describing an acoustic or psychoacoustic model of the input audio stream HOA. For example, they may comprise at least an information on a direction of arrival (DOA) or optionally information on a diffuseness or an energy ratio end of insertion.

The entity 120 performs a deriving of one or more parameters, e.g. prediction parameters/prediction coefficients.

The diffuseness and/or direction of arrival may be parameters of the mentioned acoustic model. Based on the acoustic model or based on the parameters describing the acoustic model, the prediction coefficients may be calculated by the entity 120. According to a further embodiment an interim step may be used. The prediction coefficient according to further embodiments is calculated based on a covariance matrix which is also calculated by the means for deriving 120, e.g. from the acoustic model. Often such a covariance matrix is calculated based on information about the diffuseness, spherical harmonics and/or a time-dependent scalar-valued signal. For example, the formula

$${C}_{x / y / z , w} = \int dt {s}^{2} ( t ) {Y}_{0 , 0} ( {θ}_{D} ) {Y}_{1 , - 1 / 0 / 1} ( {θ}_{D} )$$

where Y_{l,m} is a spherical harmonic with the degree and index l and m and where s(t) is a time-dependent scalar-valued signal. The discussion of the calculation of a covariance matrix has been made above in great detail. According to further embodiments the additional calculation methods as discussed above may be used.

This means, that according to embodiments the entity 120 performs the following calculation. Extracting acoustic or psychoacoustic model parameters like a DOA or diffuseness out of the audio stream HOA
deriving a covariance matrix based on set parameters of the acoustic model
calculating prediction parameters based on the covariance matrix, wherein the prediction parameters can be used by another entity, e.g. the entity 110. Consequently, the output of the entity 120 are parameters, especially prediction parameters which are forwarded to the entity 110.

The entity 110 is configured to perform transformation, e.g. downmix generation. This downmix generation is based on the input signal, here the HOA signal. However, in this case, the transformation is applied in a signal adaptive way dependent on the one or more parameters as derived by the entity 120.

Due to the novel approach that parameters, e.g. inter-channel prediction coefficients are derived from the acoustic signal model or the parameters of the acoustic signal model it is possible to perform a transformation like a mixing/down mixing in a signal-adaptive way. For example, this principle can be used to develop an extension to the DirAC system for spatial audio signals. This extension improves the quality as compared to static selection of a subset of the channel of the HOA input signal as transport channels. In addition, it reduces the metadata bit usage as compared to previous approaches to signal-adaptive transforms that reduce the inter-channel correlation. The savings on the metadata can in turn free more bits for the EVS bitstreams and further improve the perceptual quality of the system. The additional computational complexity is negligible. These advantages result directly from the derivation of a mathematical connection between the signal model considered in the DirAC system and prediction coefficients typically transmitted as side information in predictive coding schemes.

Though the principle has been discussed in context of an encoder it can also be applied to the decoder side. At the decoder side the apparatus also comprises transforming means and means for deriving one or more parameters (c.f. reference number 120) which are used at the transforming means 110. For example, the decoder receives metadata comprising information on the acoustic/psychoacoustic model or of parameters the acoustic/psychoacoustic model (in general parameters enabling to determine the prediction coefficients) together with a coded signal, like an EVS bitstream. The EVS bitstream is provided to the transforming means 110, wherein the metadata are used by the means for deriving 120. The means for deriving 120 determine based on the metadata parameters, e.g. comprising an information on a DOA. For example, the parameters to be determined may be prediction parameters. It should be noted, that metadata are derived from the audio stream e.g. at the encoder side. These parameters/prediction parameters are then used by the transforming means 110 which may be configured to perform an inverse transforming like an upmixing so as to output a decoded signal like a FOA signal which can then be further processed so as to determine the HOA signal or directly a loudspeaker signal. The further processing may, for example comprise a DirAC synthesis including an analysis filterbank.

It should be noted that the calculation of the prediction coefficients may be performed in the same way in the decoder as in the encoder. In this case, the parameters, may be preprocessed by a metadata decoder.

With respect to FIGS. 7a and 7b a detailed implementation of the above discussed approach at the decoder side and the encoder side will be discussed.

FIG. 7a shows the encoder 200 having the central entities means for transforming 110e and means for deriving one or more parameters 120e according to embodiments the means for transforming 110e can be implemented as downmix generation processing HOA data received from the input of the encoder 200. These data are processed taking into consideration the parameters received from the entity 120e, e.g. prediction coefficients. The output of the downmix generation may be fit to a bit allocation entity 212 and/or to a synthesis filterbank 214. Both data streams processed by the entities 212 and 214 are forwarded to the EVS coder 216. The EVS coder 216 performs the coding and outputs the coded stream to the multiplexer 230.

The entity 120e comprises in this embodiment two entities, namely an entity for determining a model and/or model covariance matrix which is marked by the reference numeral 121 as well as an entity for determining prediction coefficients which is marked by the reference numeral 122. According to embodiments the entity 122 performs the determination of the covariance matrix, e.g. based on one or more model parameters, like the DOA. The entity 122 determines the prediction coefficients, e.g. based on the covariance matrix.

The entity 120e may according to further embodiments receive a HOA signal or a derivative of the HOA signal e.g. preprocessed by a DirAC parameter estimator 232 and an analysis filterbank 231. The output of the DirAC parameter estimator 232 may give information on a direction of arrival (DOA as it was discussed above). This information is then used by the entity 120e and especially by the entity 121. According to further embodiments the estimated parameters of the entity 232 may also be used by a metadata encoder 233, wherein the encoded metadata stream is multiplexed together with the EVS coded stream by the multiplexer 230 so as to output the encoded HOA signal/encoded audio stream.

FIG. 7b shows the decoder 300 which comprises according to embodiments at the input a demultiplexer 330. The decoder 300 comprises the central entities 120d and 110d. The entity 110d is configured to perform a transformation, e.g. an inverse transformation like an upmixing of a signal received from the demultiplexer 330. The received input signal may be a EVS coded signal which is decoded by the entity 316 and further processed by the analysis filterbank 314. The output of the transformer 110d is a FOA signal which can then be further processed by a DirAC synthesis taking into account metadata received via the demultiplexer 330. For this, the metadata path may comprise a metadata decoder 333.

The DirAC synthesis entity is marked by the reference numeral 335 the output of the DirAC synthesis entity 335 may be further processed by a synthesis filterbank 336 so as to output a HOA signal or headphone/loudspeaker signal.

The metadata, e.g. the metadata decoded by the metadata decoder 333 are used for determining the parameters obtained by the entity 120d. In this case, the entity 120d comprised the two entities for determining the model/the model covariance matrix as marked by reference numeral 121 and the entity for determining the prediction coefficients/general parameters (marked by the reference numeral 122). The output of the entity 120d is used for the transformation performed by the entity 110d.

Below, further aspects may be discussed. The above discussed embodiments start from the assumption, that an audio stream with more than one channel should be transformed into another representation. The above discussed embodiments may also be applied for transforming audio streams in a directional audio coding system. Thus embodiments provide an apparatus and method to transform audio streams in a directional audio coding system where
a) acoustic model parameters are transmitted to restore all channels of the input signal,
b) the parameters comprise at least one (or more) DOA and diffuseness,
c) the transmitted audio streams are derived by transforming all or a subset of the channels of the input signal,
d) this transform is derived from a model of the input signal parametrized by the DOA and diffuseness parameters, and
e) this transform is calculated in a signal-adaptive way independently on both the encoder and decoder side.

According to embodiment a sound scheme can be rotated in such a way that
a) the vector of the transport channel signals is pre-multiplied by a rotation matrix in a suitable domain,
b) the model parameters and/or prediction coefficients are transformed in accordance with the transform of the transport channel signals, and
c) the non-transport channels of the output signal are reconstructed using these transformed model parameters and/or prediction coefficients.

In general embodiments refer to an apparatus and method to transform audio streams with more than one channel into another representation such that
a) the transform is derived from parameters describing an acoustic or psychoacoustic model of the signal,
b) these parameters comprise at least one DOA and diffuseness, and
c) the transform is calculated in a signal-adaptive way.

According to further embodiments the transform is computed such that correlations between the transport channels are reduced. For example, an inter-channel covariance matrix may be used. Here the inter-channel covariance matrix of the input signal is estimated from a model of the signal. According to further embodiments a transform matrix is derived from the covariance matrix of the model. According to embodiments such as for matrices calculated using different methods for different frequency bands.

In the following, additional embodiments and aspects of the invention will be described which can be used individually or in combination with any of the features and functionalities and details described herein.

A first aspect relates to an apparatus for transforming an audio stream with more than one channel into another representation, apparatus being on an encoder side and comprising: means for deriving one or more parameters describing an acoustic or psychoacoustic model of the audio stream on the encoder side, wherein the means for deriving are configured to calculate prediction coefficients as the one or more parameters, wherein the prediction coefficients are calculated based on a covariance matrix by the means for deriving; means for transforming the audio stream in a signal-adaptive way dependent on the one or more parameters; and wherein the one or more parameters comprise at least an information on at least one direction of arrival (DOA), wherein the means for transforming are configured to perform a downmixing or other transforming of the audio stream on the encoder side.

A second aspect relates to an apparatus for transforming an audio stream with more than one channel into another representation apparatus being on a decoder side and comprising: means for receiving one or more parameters describing an audio scene with an acoustic or psychoacoustic model on the decoder side; means for transforming the audio stream in a signal-adaptive way dependent on the one or more parameters; and wherein the one or more parameters comprise at least an information on at least one direction of arrival (DOA), wherein the means for transforming are configured to perform upmix or other transform generation of the audio stream on the decoder side.

According to a third aspect when referring back to the first aspect, prediction coefficients are calculated based on Y_{l,m}, especially beads on the formula

$$P = ( \begin{matrix}1 & 0 & 0 & 0 \\ - {C}_{x , w} / {C}_{w , w} & 1 & 0 & 0 \\ - {C}_{y , w} / {C}_{w , w} & 0 & 1 & 0 \\ - {C}_{z , w} / {C}_{w , w} & 0 & 0 & 1\end{matrix} ) , \qquad ( 4 )$$

with the matrix elements

$${C}_{x / y / z , w} = {E}^{dir} {Y}_{0 , 0} ( {θ}_{D} ) {Y}_{1 , - 1 / 0 / 1} ( {θ}_{D} ) \\ and \\ {C}_{w , w} = {E}^{dir} {Y}_{0 , 0} ( {θ}_{D} ) {Y}_{0 , 0} ( {θ}_{D} ) + {E}_{w}^{diff} \qquad ( 13 )$$

where Y_{l,m} are real spherical harmonics with degree and index l and m.

According to a fourth aspect when referring back to any of the previous aspects, the one or more parameters further comprise at least an information on a diffuseness factor or on one or more DOAs or on energy ratios, and/or wherein the one or more parameters are derived from the audio stream.

According to a fifth aspect when referring back to the first aspect, the means for deriving are configured to calculate a covariance matrix or a covariance matrix from the acoustic or psychoacoustic model.

According to a sixth aspect when referring back to any of the previous aspects, the means for deriving are configured to calculate a covariance matrix based on the DoA and a diffuseness factor or an energy ratio.

According to a seventh aspect when referring back to the sixth aspect, the means for deriving are configured to calculate a covariance matrix based on an information about diffuseness, spherical harmonics and a time-dependent scalar-valued signal, especially based on the formula

$${C}_{x / y / z , w} = \int dt {s}^{2} ( t ) {Y}_{0 , 0} ( {θ}_{D} ) {Y}_{1 , - 1 / 0 / 1} ( {θ}_{D} )$$

where Y_{l,m} is a spherical harmonic with the degree and index l and m and where s (t) is a time-dependent scalar-valued signal; and/or
based on a signal energy, especially based on the following formula

$${C}_{x / y / z , w} = ( 1 - Ψ ) {EY}_{0 , 0} ( {θ}_{D} ) {Y}_{1 , - 1 / 0 / 1} ( {θ}_{D} )$$

where ψ describes the diffuseness and where E describes the signal energy for the audio stream; and/or based on the formula

$${C}_{w , w} = ( 1 - Ψ ) {EY}_{0 , 0} ( {θ}_{D} ) {Y}_{0 , 0} ( {θ}_{D} ) + Ψ E$$

where E is the signal energy; and/or based on the formula

$${C}_{x , x} = ( 1 - Ψ ) {EY}_{1 , - 1} ( {θ}_{D} ) {Y}_{1 , - 1} ( {θ}_{D} ) + \frac{Ψ}{3} E$$

and for the y and z channels analogously.

According to an eighth aspect when referring back to the seventh aspect, the signal energy E is directly calculated from the audio stream; or the signal energy E is estimated from the model of the audio stream.

According to a ninth aspect when referring back to any of the previous aspects, the audio stream is preprocessed by a parameter estimator or wherein the audio stream is preprocessed by a parameter estimator comprising a metadata encoder or metadata decoder and/or wherein the audio stream is preprocessed by an analysis filterbank.

A tenth aspect relates to an apparatus for transforming an audio stream in a directional audio coding system, being on an encoder side and comprising: means for deriving one or more acoustic model parameters of a model of the audio stream, wherein the one or more acoustic model parameters are transmitted to enable restoring all channels of the audio stream and comprise at least an information on direction of arrival (DoA), means for transforming the audio stream in a signal-adaptive way dependent on the one or more acoustic model parameters; where all or a subset of the channels of the audio stream are transformed; wherein the means for transforming are configured to perform a downmixing or other transforming of the audio stream on the encoder side.

An eleventh aspect relates to an apparatus for transforming an audio stream in a directional audio coding system, apparatus being on a decoder side and comprising: means for receiving one or more acoustic model parameters of a model of the audio stream, wherein the one or more acoustic model parameters are received to restore all channels of the audio stream and comprise at least an information on direction of arrival (DoA), means for transforming the audio stream in a signal-adaptive way dependent on the one or more acoustic model parameters; where all or a subset of the channels of the audio stream are transformed; wherein the means for transforming are configured to perform upmix or other transform generation of the audio stream on the decoder side.

According to a twelfth aspect when referring back to any of the previous aspects, the one or more parameters are quantized prior to a transmission.

According to a thirteenth aspect when referring back to any of the previous aspects, the one or more parameters are dequantized after a transmission.

According to a fourteenth aspect when referring back to any of the previous aspects, the parameters are smoothed over time.

According to a fifteenth aspect when referring back to any of the previous aspects, a transform is computed such that correlations between transport channels are reduced by use of Karhunen-Loève transform or prediction matrix.

According to a sixteenth aspect when referring back to any of the previous aspects, an inter-channel covariance matrix of the audio stream is estimated from the model or the acoustic or psychoacoustic model of the audio stream.

According to a seventeenth aspect when referring back to any of the previous aspects, a transform matrix is derived from a covariance matrix of the model or the acoustic or psychoacoustic model of the audio stream.

According to an eighteenth aspect when referring back to any of the previous aspects, a transform matrix is calculated using the covariance matrix from the acoustic or psychoacoustic model for one or more frequency bands and a different method to calculate the covariance matrix for one or more other frequency bands

According to a nineteenth aspect when referring back to any of the previous aspects, at least one of transform methods used by the means for transforming is multiplication of a vector of audio channels by a constant matrix.

According to a twentieth aspect when referring back to any of the previous aspects, at least one of transform methods used by the means for transforming uses prediction based on the inter-channel covariance matrix of a vector of audio channels.

According to a twenty-first aspect when referring back to any of the previous aspects, at least one of transform methods used by the means for transforming uses prediction based on inter-channel covariance matrix based on the DOA and an additional diffuseness factor or an energy ratio.

According to a twenty-second aspect when referring back to any of the previous aspects, the means for deriving the one or more parameters are configured to process all or a subset of the channels of a first-order or higher-order Ambisonics input signal of the audio stream.

According to a twenty-third aspect when referring back to any one of aspects 10-22, a sound scene of the audio stream is rotatable in such a way that:
an audio signal in the spherical-harmonics domain resulting from a transform is pre-multiplied by a rotation matrix;
model parameters and/or prediction coefficients are transformed in accordance with the transform of a transport channel signal; and
non-transport channels of an output signal are reconstructed using the transformed model and/or prediction coefficients parameters.

A twenty-fourth aspect relates to an encoder comprising an apparatus according to one of the aspects 1, 3-22 having backreference to aspect 1.

A twenty-fifth aspect relates to a decoder comprising an apparatus according to one of the aspects 2 or 3-22 having backreference to aspects 2.

A twenty-sixth aspect relates to a system comprising an encoder according to aspect 24 and a decoder according to aspect 25, wherein the encoder is configured to calculate a prediction matrix and/or a downmix or other transform and wherein decoder is configured to calculate an upmix or other transform matrix from estimated parameters or the one or more parameters of the acoustic model independently of each other.

A twenty-sixth aspect relates to a method for transforming an audio stream with more than one channel into another representation, performed on an encoder side and comprising the following steps: deriving the one or more parameters describing an acoustic or psychoacoustic model of an audio stream from the audio stream, wherein deriving comprises calculating prediction coefficients as the one or more parameters, wherein the prediction coefficients calculated are calculated based on a covariance matrix by the means for deriving and wherein the one or more parameters comprise at least an information on direction of arrival (DOA); and transforming the audio stream in a signal-adaptive way dependent the on one or more parameters; wherein transforming comprises a downmixing or other transforming of the audio stream on the encoder side.

A twenty-eighth aspect relates to a method for transforming an audio stream with more than one channel into another representation, performed on a decoder side and comprising the following steps: receiving one or more parameters describing an audio scene with an acoustic or psychoacoustic model on the decoder side, wherein the one or more parameters comprise at least an information on direction of arrival (DOA); and transforming the audio stream in a signal-adaptive way dependent the on one or more parameters; wherein transforming comprises upmixing or other transforming of the audio stream on the decoder side.

A twenty-ninth aspect relates to a method for transforming an audio stream in a directional audio coding system, performed on an encoder side and comprising the steps: deriving one or more acoustic model parameters of a model of the audio stream parametrized by direction of arrival (DOA) and diffuseness or energy-ratio parameters, said acoustic model parameters are transmitted to restore all channels of an input of audio stream and comprise at least an information on DOA, wherein all or a subset of the channels of the audio stream are transformed; and transforming the audio stream in a signal-adaptive way dependent on one or more acoustic model parameters, wherein transforming comprises a downmixing or other transforming of the audio stream on the encoder side.

A thirtieth aspect relates to a method for transforming an audio stream in a directional audio coding system, performed on a decoder side and comprising the steps: receiving one or more acoustic model parameters of a model of the audio stream parametrized by direction of arrival (DOA) and diffuseness or energy-ratio parameters, said acoustic model parameters are received to restore all channels of an input of audio stream and comprise at least an information on DOA, wherein all or a subset of the channels of the audio stream are transformed; and transforming the audio stream in a signal-adaptive way dependent on one or more acoustic model parameters, wherein transforming comprises upmixing or other transforming of the audio stream on the decoder side.

A thirty-first aspect relates to a computer program for performing, when running on a computer, any of the above methods according to the invention.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, some one or more of the most important method steps may be executed by such an apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] Ville Pulkki. Directional audio coding in spatial sound reproduction and stereo upmixing. In Audio Engineering Society Conference: 28th International Conference: The Future of Audio Technology—Surround and Beyond, June 2006.
[2] Ville Pulkki. Spatial sound reproduction with directional audio coding. J. Audio Eng. Soc, 55(6):503-516, 2007. V. Pulkki, M-V. Laitinen, J. Vilkamo, J. Ahonen, T. Lokki, and T. Pihlajamäki. Directional audio coding—perception-based reproduction of spatial sound. 2009.
[3] Andrea Eichenseer, Srikanth Korse, Oliver Thiergart, Guillaume Fuchs, Markus Multrus, Stefan Bayer, Dominik Weckbecker, Jürgen Herre, and Fabian Küch. Parametric coding of object-based audio using directional audio coding. Internal document Fraunhofer IIS, 2020.
[4] Toni Hirvonen, Jukka Ahonen, and Ville Pulkki. Perceptual compression methods for metadata in directional audio coding applied to audiovisual teleconference. In Audio Engineering Society Convention 126, May 2009.
[5] Guillaume Fuchs, Jürgen Herre, Fabian Küch, Stefan Dohla, Markus Multrus, Oliver Thiergart, Oliver Wübbolt, Florin Ghido, Stefan Bayer, and Wolfgang Jaegers. Apparatus and method for encoding or decoding directional audio coding parameters using quantization and entropy coding. United States Patent Application Publication US 2020/0265851 A1, August 2020.
[6] Ville Pulkki. Virtual sound source positioning using vector base amplitude panning. J. Audio Eng. Soc, 45(6):456-466, 1997.
[7] Dolby Laboratories Inc. Dolby vrstream audio profile candidate—description of bitstream, decoder, and renderer plus informative encoder description. Technical report, Dolby Laboratories Inc., 2018.
[8] Markus Noisternig, Alois Sontacchi, Thomas Musil, and Robert Holdrich. A 3d ambisonic based binaural sound reproduction system. In Audio Engineering Society Conference: 24th International Conference: Multichannel Audio, The New Reality, June 2003.
[9] Maximilian Neumayer. Evaluation of soundfield rotation methods in the context of dynamic binaural rendering of higher order ambisonics. Master's thesis, Technische Universität Berlin, 2017.
[10] Adam Mckeag and David S. McGrath. Sound Field Format to Binaural Decoder with Head Tracking. Audio Engineering Society, August 1996.
[11] Joseph Ivanic and Klaus Ruedenberg. Rotation matrices for real spherical harmonics. direct determination by recursion. The Journal of Physical Chemistry, 100(15):6342-6347, 1996.
[12] Dai Yang, Hongmei Ai, C. Kyriakakis, and C.-C. J. Kuo. High-fidelity multichannel audio coding with karhunen-loeve transform. IEEE Transactions on Speech and Audio Processing, 11(4):365-380, 2003.
[13] https://dlmf.nist.gov/1.17#E25.
[14] M. Risoud, J.-N. Hanson, F. Gauvrit, C. Renard, P.-E. Lemesre, N.-X. Bonne, and C. Vincent. Sound source localization. European Annals of Otorhinolaryngology, Head and Neck Diseases, 135(4):259-264, 2018.
[15] Sascha Disch, Andreas Niedermeier, Christian R. Helmrich, Christian Neukam, Konstantin Schmidt, Ralf Geiger, Je're'mie Lecomte, Florin Ghido, Frederik Nagel, and Bernd Edler. Intelligent gap filling in perceptual transform coding of audio. In Audio Engineering Society Convention 141, September 2016.
[16] Sascha Disch, Andreas Niedermeier, Christian R. Helmrich, Christian Neukam, Konstantin Schmidt, Ralf Geiger, Je're'mie Lecomte, Florin Ghido, Frederik Nagel, and Bernd Edler. Intelligent gap filling in perceptual transform coding of audio. In Audio Engineering Society Convention 141, September 2016.

1. Apparatus for transforming an audio stream with more than one channel into another representation, apparatus being on an encoder side and comprising:
unit for deriving one or more parameters describing an acoustic or psychoacoustic model of the audio stream on the encoder side, wherein the unit for deriving is configured to calculate prediction coefficients as the one or more parameters, wherein the prediction coefficients are calculated based on a covariance matrix by the unit for deriving;
transformer for transforming the audio stream in a signal-adaptive way dependent on the one or more parameters; and
wherein the one or more parameters comprise at least an information on at least one direction of arrival (DOA),
wherein the transformer is configured to perform a downmixing or other transforming of the audio stream on the encoder side.

2. Apparatus for transforming an audio stream with more than one channel into another representation apparatus being on a decoder side and comprising:
receiver for receiving one or more parameters describing an audio scene with an acoustic or psychoacoustic model on the decoder side;
transformer for transforming the audio stream in a signal-adaptive way dependent on the one or more parameters; and
wherein the one or more parameters comprise at least an information on at least one direction of arrival (DOA),
wherein the transformer is configured to perform upmix or other transform generation of the audio stream on the decoder side.

3. Apparatus according to claim 1, wherein prediction coefficients are calculated based on Y_{l,m}, especially beads on the formula
$$P = ( \begin{matrix}1 & 0 & 0 & 0 \\ - {C}_{x , w} / {C}_{w , w} & 1 & 0 & 0 \\ - {C}_{y , w} / {C}_{w , w} & 0 & 1 & 0 \\ - {C}_{z , w} / {C}_{w , w} & 0 & 0 & 1\end{matrix} ) , \qquad ( 4 )$$
with the matrix elements
$${C}_{x / y / z , w} = {E}^{dir} {Y}_{0 , 0} ( {θ}_{D} ) {Y}_{1 , - 1 / 0 / 1} ( {θ}_{D} ) \\ and \\ {C}_{w , w} = {E}^{dir} {Y}_{0 , 0} ( {θ}_{D} ) {Y}_{0 , 0} ( {θ}_{D} ) + {E}_{w}^{diff} \qquad ( 13 )$$
where Y_{l,m} are real spherical harmonics with degree and index l and m.

4. Apparatus according to claim 1, wherein the one or more parameters further comprise at least an information on a diffuseness factor or on one or more DOAs or on energy ratios, and/or wherein the one or more parameters are derived from the audio stream.

5. Apparatus according to claim 1, wherein the unit for deriving is configured to calculate a covariance matrix or a covariance matrix from the acoustic or psychoacoustic model.

6. Apparatus according to claim 1, wherein the unit for deriving is configured to calculate a covariance matrix based on the DoA and a diffuseness factor or an energy ratio.

7. Apparatus according to claim 6, wherein the unit for deriving is configured to calculate a covariance matrix based on an information about diffuseness, spherical harmonics and a time-dependent scalar-valued signal, especially based on the formula
$${C}_{x / y / z , w} = \int dt {s}^{2} ( t ) {Y}_{0 , 0} ( {θ}_{D} ) {Y}_{1 , - 1 / 0 / 1} ( {θ}_{D} )$$
where Y_{l,m} is a spherical harmonic with the degree and index l and m and where s(t) is a time-dependent scalar-valued signal; and/or
based on a signal energy, especially based on the following formula
$${C}_{x / y / z , w} = ( 1 - Ψ ) {EY}_{0 , 0} ( {θ}_{D} ) {Y}_{1 , - 1 / 0 / 1} ( {θ}_{D} )$$
where ψ describes the diffuseness and where E describes the signal energy for the audio stream; and/or based on the formula
$${C}_{w , w} = ( 1 - Ψ ) {EY}_{0 , 0} ( {θ}_{D} ) {Y}_{0 , 0} ( {θ}_{D} ) + Ψ E$$
where E is the signal energy; and/or based on the formula
$${C}_{x , x} = ( 1 - Ψ ) {EY}_{1 , - 1} ( {θ}_{D} ) {Y}_{1 , - 1} ( {θ}_{D} ) + \frac{Ψ}{3} E$$
and for the y and z channels analogously.

8. Apparatus according to claim 7, wherein the signal energy E is directly calculated from the audio stream; or
wherein the signal energy E is estimated from the model of the audio stream.

9. Apparatus according to claim 1, wherein the audio stream is preprocessed by a parameter estimator or wherein the audio stream is preprocessed by a parameter estimator comprising a metadata encoder or metadata decoder and/or wherein the audio stream is preprocessed by an analysis filterbank.

10. Apparatus for transforming an audio stream in a directional audio coding system, being on an encoder side and comprising:
unit for deriving one or more acoustic model parameters of a model of the audio stream, wherein the one or more acoustic model parameters are transmitted to enable restoring all channels of the audio stream and comprise at least an information on direction of arrival (DoA),
transformer for transforming the audio stream in a signal-adaptive way dependent on the one or more acoustic model parameters; where all or a subset of the channels of the audio stream are transformed;
wherein the transformer is configured to perform a downmixing or other transforming of the audio stream on the encoder side.

11. Apparatus for transforming an audio stream in a directional audio coding system, apparatus being on a decoder side and comprising:
receiver for receiving one or more acoustic model parameters of a model of the audio stream, wherein the one or more acoustic model parameters are received to restore all channels of the audio stream and comprise at least an information on direction of arrival (DoA),
transformer for transforming the audio stream in a signal-adaptive way dependent on the one or more acoustic model parameters; where all or a subset of the channels of the audio stream are transformed;
wherein the transformer is configured to perform upmix or other transform generation of the audio stream on the decoder side.

12. Apparatus according to claim 1, wherein the one or more parameters are quantized prior to a transmission.

13. Apparatus according to claim 1, wherein the one or more parameters are dequantized after a transmission.

14. Apparatus according to claim 1, wherein the parameters are smoothed over time.

15. Apparatus according to claim 1, wherein a transform is computed such that correlations between transport channels are reduced by use of Karhunen-Loève transform or prediction matrix.

16. Apparatus according to claim 1, wherein an inter-channel covariance matrix of the audio stream is estimated from the model or the acoustic or psychoacoustic model of the audio stream.

17. Apparatus according to claim 1, wherein a transform matrix is derived from a covariance matrix of the model or the acoustic or psychoacoustic model of the audio stream.

18. Apparatus according to claim 1, wherein a transform matrix is calculated using the covariance matrix from the acoustic or psychoacoustic model for one or more frequency bands and a different method to calculate the covariance matrix for one or more other frequency bands

19. Apparatus according to claim 1, wherein at least one of transform methods used by the transformer is multiplication of a vector of audio channels by a constant matrix.

20. Apparatus according to claim 1, wherein at least one of transform methods used by the transformer uses prediction based on the inter-channel covariance matrix of a vector of audio channels.

21. Apparatus according to claim 1, wherein at least one of transform methods used by the transformer uses prediction based on inter-channel covariance matrix based on the DOA and an additional diffuseness factor or an energy ratio.

22. Apparatus according to claim 1, wherein the unit for deriving the one or more parameters is configured to process all or a subset of the channels of a first-order or higher-order Ambisonics input signal of the audio stream.

23. Apparatus according to claim 10, wherein a sound scene of the audio stream is rotatable in such a way that:
an audio signal in the spherical-harmonics domain resulting from a transform is pre-multiplied by a rotation matrix;
model parameters and/or prediction coefficients are transformed in accordance with the transform of a transport channel signal; and
non-transport channels of an output signal are reconstructed using the transformed model and/or prediction coefficients parameters.

24. Encoder comprising an apparatus according to claim 1.

25. Decoder comprising an apparatus according to claim 2.

26. A system comprising
an encoder comprising
an apparatus for transforming an audio stream with more than one channel into another representation, apparatus being on an encoder side and comprising:
unit for deriving one or more parameters describing an acoustic or psychoacoustic model of the audio stream on the encoder side, wherein the unit for deriving is configured to calculate prediction coefficients as the one or more parameters, wherein the prediction coefficients are calculated based on a covariance matrix by the unit for deriving;
transformer for transforming the audio stream in a signal-adaptive way dependent on the one or more parameters; and
wherein the one or more parameters comprise at least an information on at least one direction of arrival (DOA),
wherein the transformer is configured to perform a downmixing or other transforming of the audio stream on the encoder side, and
a decoder according to claim 25, wherein the encoder is configured to calculate a prediction matrix and/or a downmix or other transform and wherein the decoder is configured to calculate an upmix or other transform matrix from estimated parameters or the one or more parameters of the acoustic model independently of each other.

27. Method for transforming an audio stream with more than one channel into another representation, performed on an encoder side and comprising:
deriving the one or more parameters describing an acoustic or psychoacoustic model of an audio stream from the audio stream, wherein deriving comprises calculating prediction coefficients as the one or more parameters, wherein the prediction coefficients calculated are calculated based on a covariance matrix by the unit for deriving and wherein the one or more parameters comprise at least an information on direction of arrival (DOA); and
transforming the audio stream in a signal-adaptive way dependent the on one or more parameters; wherein transforming comprises a downmixing or other transforming of the audio stream on the encoder side.

28. Method for transforming an audio stream with more than one channel into another representation, performed on a decoder side and comprising:
receiving one or more parameters describing an audio scene with an acoustic or psychoacoustic model on the decoder side, wherein the one or more parameters comprise at least an information on direction of arrival (DOA); and
transforming the audio stream in a signal-adaptive way dependent the on one or more parameters; wherein transforming comprises upmixing or other transforming of the audio stream on the decoder side.

29. Method for transforming an audio stream in a directional audio coding system, performed on an encoder side and comprising:
deriving one or more acoustic model parameters of a model of the audio stream parametrized by direction of arrival (DOA) and diffuseness or energy-ratio parameters, said acoustic model parameters are transmitted to restore all channels of an input of audio stream and comprise at least an information on DOA, wherein all or a subset of the channels of the audio stream are transformed; and
transforming the audio stream in a signal-adaptive way dependent on one or more acoustic model parameters, wherein transforming comprises a downmixing or other transforming of the audio stream on the encoder side.

30. Method for transforming an audio stream in a directional audio coding system, performed on a decoder side and comprising:
receiving one or more acoustic model parameters of a model of the audio stream parametrized by direction of arrival (DOA) and diffuseness or energy-ratio parameters, said acoustic model parameters are received to restore all channels of an input of audio stream and comprise at least an information on DOA, wherein all or a subset of the channels of the audio stream are transformed; and
transforming the audio stream in a signal-adaptive way dependent on one or more acoustic model parameters, wherein transforming comprises upmixing or other transforming of the audio stream on the decoder side.

31. Non-transitory digital storage medium having stored thereon a computer program for performing the method of claim 27, when the computer program is run by a computer.
